(19) United States
(12) Patent Application Publication
(10) Pub. No.: US 2014/0023221 A1
(43) Pub. Date: Jan. 23, 2014

(54) MOBILE ENTERTAINMENT DEVICE

(71) Applicant: Steven Robert Weinstein, Windermere, FL (US)

(72) Inventor: Steven Robert Weinstein, Windermere, FL (US)

(21) Appl. No.: 13/946,241

(22) Filed: Jul. 19, 2013

Related U.S. Application Data
(60) Provisional application No. 61/673,584, filed on Jul. 19, 2012.

(51) Int. Cl. H04R 1/02

(52) U.S. Cl. CPC H04R 1/02
USPC 381/334

(57) ABSTRACT

A movable cart that provides entertainment. The present invention may include a housing with wheels. The housing may include a rechargeable battery that powers at least one speaker system mounted to the housing. The housing may further include multiple outlets to plug in other equipment, such as laptops, tablets, mixers and the like. The equipment may be connected to and play audio using the speakers.

### CROSS-REFERENCE TO RELATED APPLICATION

This application claims the benefit of priority of U.S. provisional application No. 61/673,584, filed Jul. 19, 2012, the contents of which are herein incorporated by reference.

### BACKGROUND OF THE INVENTION

The present invention relates to a mobile entertainment device and, more particularly, to a mobile entertainment device that may include music playing capabilities.

A disc jockey, also known as DJ, is a person who plays recorded music for an audience. There are several types of disc jockeys. Club DJs select and play music in bars, nightclubs, discos, parties, raves or even stadiums. Disc jockey equipment may include sound recordings, computer media players, sequencers, sound systems, mixers, headphones, microphones and the like. Typically a DJ playing at a nightclub, bars etc. tend to have a lot of equipment that needs to be set up for every performance. The setup may be time consuming and cumbersome, and equipment may become lost or stolen.

As can be seen, there is a need for a mobile entertainment and music playing device.

### SUMMARY OF THE INVENTION

In one aspect of the present invention, a mobile entertainment device comprises: a housing comprising a front side, a rear side, a first side, a second side, top portion and a bottom portion; a rechargeable battery within the housing connected to outlets positioned on an outer surface of the housing; at least one speaker system powered by the rechargeable battery, wherein the speaker system is attached to the housing; and a plurality of wheels connected to the bottom portion of the housing.

These and other features, aspects and advantages of the present invention will become better understood with reference to the following drawings, description and claims.

### BRIEF DESCRIPTION OF THE DRAWINGS

FIG. 1 is a perspective view of the present invention;

FIG. 2 is a rear view of the present invention;

FIG. 3 is a side view of the present invention; and

FIG. 4 is a front view of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a movable cart that provides entertainment. The present invention may include a housing with wheels. The housing may include a rechargeable battery that powers at least one speaker system mounted to the housing. The housing may further include multiple outlets to plug in other equipment, such as laptops, tablets, mixers and the like. The equipment may be connected to and play audio using the speakers.

The present invention may include a moving cart with a rechargeable battery to power all of the equipment of the disc jockey. For example, the cart may be used to power a laptop, tablet, karaoke machine, video, speakers, microphones, monitors, mixers, lights, multiple outputs and the like. The present invention may be able to run on a rechargeable battery without the need to connect the battery to an outlet, which makes the present invention mobile. The present invention may provide high quality sound, lighting, karaoke music, videos, and may be able to entertain a large crowd with little to no setup and within a small area.

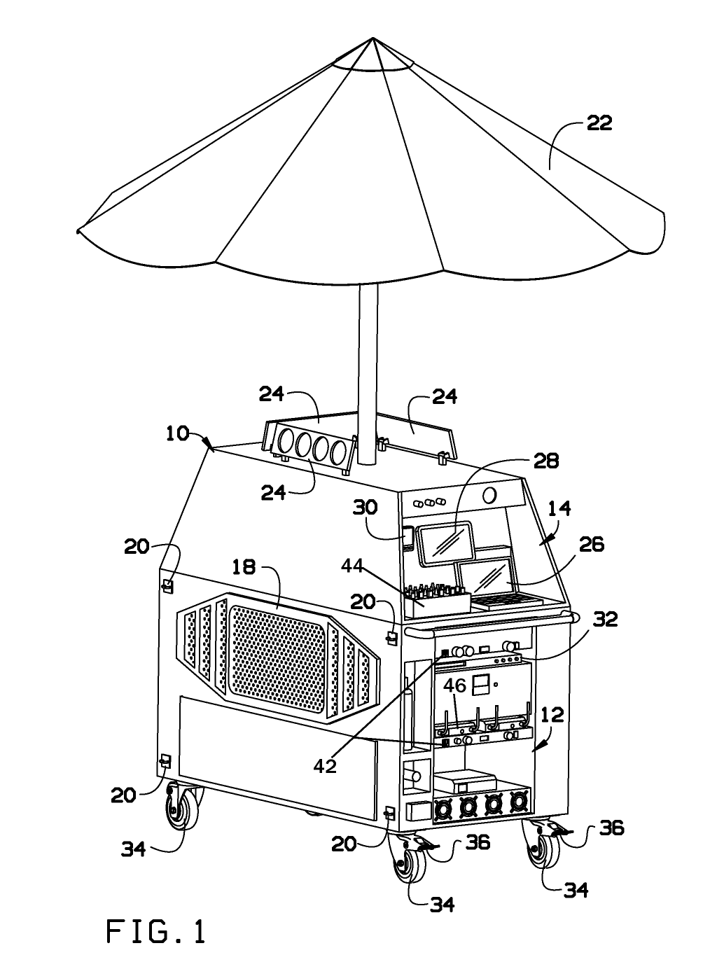

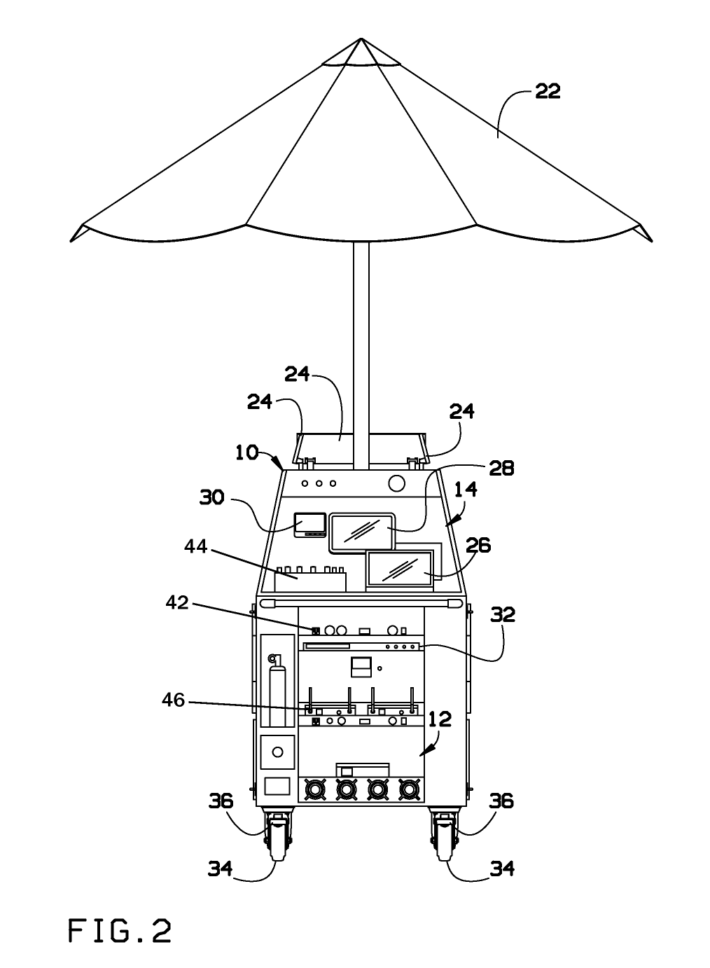

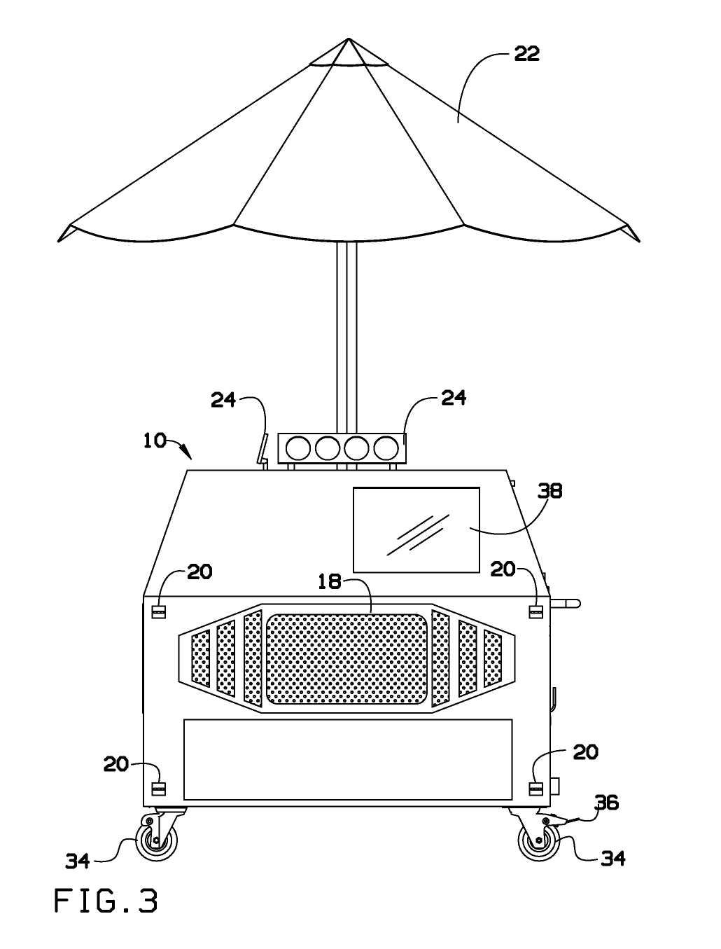

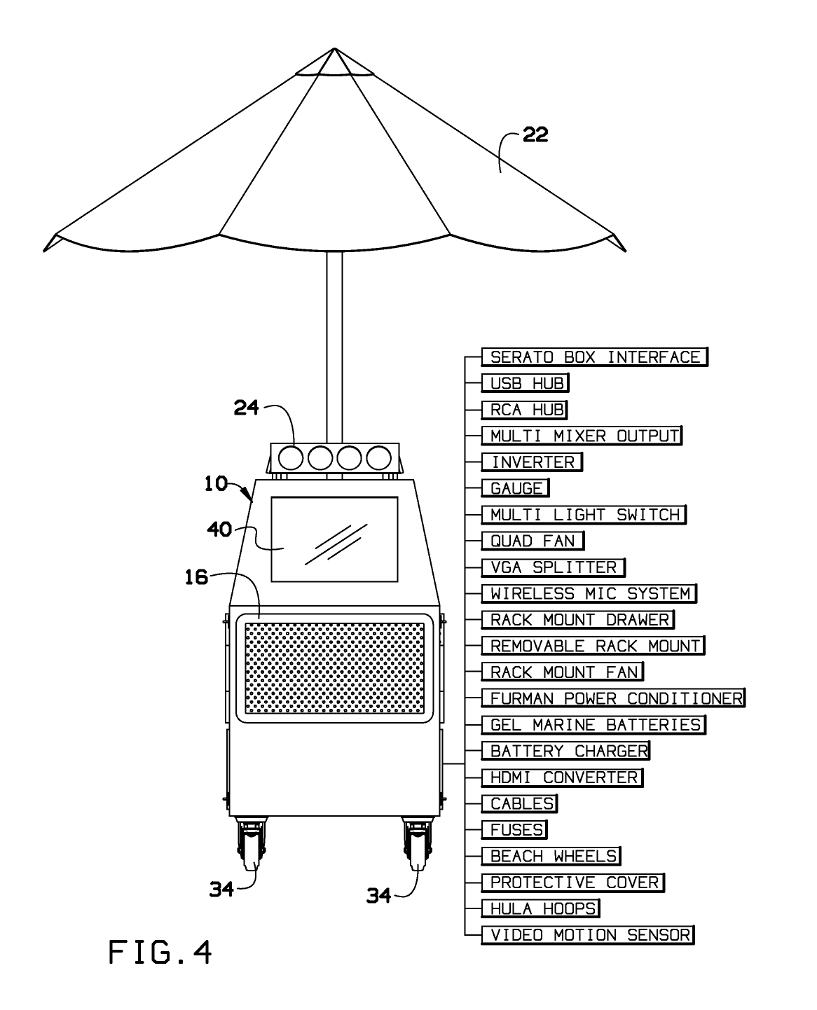

Referring to FIGS. 1 through 4, the present invention may include a housing 10 that may include internal and external components. The housing 10 of the present invention may include an internal rechargeable battery. In certain embodiments, the battery may include 6 optima Gel Marine Batteries. The rechargeable battery may include a power cord to plug into a power source in order to charge the battery. In certain embodiment, a power cord may be plugged into the rechargeable battery in order to charge the battery.

In certain embodiments, the battery may be connected to an inverter. The power inverter may change direct current coming from the battery into alternating current. The present invention may further include an electrical junction box, which may contain electrical connections. The inverter may be wired through the electrical junction box. The inverter may be connected to a plurality of outlets 42. For example, the inverter may be connected to a rack mount power strip that includes a plurality of outlets 42. Electrical devices may be connected to the outlets 42, which provide power from the battery.

The housing 10 of the present invention may include a front side, a rear side, a first side, a second side, a top portion, and a bottom portion. In certain embodiments, the present invention may include at least one speaker 16, 18. For example, the speaker 16, 18 may include a forward speaker 16 located on the front side of the housing 10 and a side speaker 18 located on at least one of the first side and the second side. In certain embodiments, the present invention may further include video monitors 38, 40. For example, the monitors 38, 40 may include side monitors 38 and a front monitor 40. The speakers 16, 18 and monitors 38, 40 may be powered by the battery.

The housing 10 of the present invention may be a mobile housing 10. For example, the housing 10 may include a plurality of wheels 34 attached to the bottom. Therefore, a user may easily move the housing 10 from one area to another. The wheels 34 may be rubber and/or alloy. In certain embodiments, the wheels 34 of the present invention may further include breaking mechanisms. For example, the wheels 34 may include foot brakes 36 so that a user may stop the housing 10 from moving. The wheels 34 may further include locks so that a user may lock the housing 10 to prevent further movement. For example, if the housing 10 is on a hill, the lock may prevent the wheels from moving. The housing 10 may further include mounted hooks 20, such as retractable hooks, for towing purposes.

In certain embodiments, the housing 10 of the present invention may further include a control station 14 to support equipment. The control station 14 may be near the top end of the housing 10 so that a user may easily access the equipment on the control station 14. As illustrated in the Figures, the control station 14 may include a laptop 26, a tablet 28, a video-backup monitor 30, and a mixer 44. The equipment on the control station 14 may all be interconnected and may be operatively connected to the speakers 16, 18 and/or monitors 38, 40 either by hard wire or wirelessly. Further, the equipment in the control station 14 may be connected to the outlets 42 for power. Using the equipment in the control station 14, a user may control the video displayed on the monitors 38, 40 and the audio playing from the speakers 16, 18.

In certain embodiments, the present invention may further include shelving 12. The shelving 12 provides additional space to for additional equipment. For example, the shelving 12 may support players 32 such as DVD and/or USB players. The shelving 12 may further provide space for wireless transmitters and receivers 46, fans, music and video inputs, fire extinguishers, and the like. The shelving 12 may further include outlets 42 to power the equipment within the shelving 12.

The present invention may further include multiple add-ons and accessories. For example, the present invention may include lights 24, such as strobe lights and platform lights. The present invention may include an umbrella 22 to protect the housing 10 and electronic equipment from inclement weather. The present invention may further include, but is not limited to: a Serato® box/interface, USB HUB, RCA HUB, multi mixer output(XLR, RCA, quarter inch), power button for inverter, a gauge for power, multi light switch, a quad fan, VGA splitter, a microphone system such as a wireless microphone system, Rack mount drawer, Removable rack mount, Furman® power conditioner/voltage meter, HDMI Converter, two 24 inch monitors and one 19 inch monitor, Fuses for battery, Fuses for Inverter, four 49 CM PU beach wheels for beach cruising, weather protective covering with motor base inlet with 15 Amps and 125V, a hula hoop, plexy glass to cover the monitors, video sensor, backup audio sensor, battery disconnects, surge protection inverter, and the like.

It should be understood, of course, that the foregoing relates to exemplary embodiments of the invention and that modifications may be made without departing from the spirit and scope of the invention as set forth in the following claims.

What is claimed is:

1. A mobile entertainment device comprising:
a housing comprising a front side, a rear side, a first side, a second side, top portion and a bottom portion;
a rechargeable battery within the housing connected to outlets positioned on an outer surface of the housing;
at least one speaker system powered by the rechargeable battery, wherein the speaker system is attached to the housing; and
a plurality of wheels connected to the bottom portion of the housing.

2. The mobile entertainment device of claim 1, further comprising at least one rack mount power strip comprising the outlets.

3. The mobile entertainment device of claim 1, wherein the at least one speaker system comprises a front speaker located on the front side of the housing and a side speaker located on at least one of the first side and the second side of the housing

4. The mobile entertainment device of claim 1, further comprising monitors attached to the housing and powered by the rechargeable battery.

5. The mobile entertainment device of claim 1, further comprising a breaking and locking mechanism on the wheels.

6. The mobile entertainment device of claim 1, further comprising a control station formed near the top end of the housing, wherein the control station comprises a support and a plurality of outlets.

7. The mobile entertainment device of claim 6, wherein the control station comprises equipment comprising at least one of a laptop computer, a tablet, a video-backup monitor, and a mixer, wherein the equipment is operatively connected to the at least one speaker system.

8. The mobile entertainment device of claim 1, further comprising shelves built into the housing.

9. The mobile entertainment device of claim 1, wherein the shelves comprise equipment comprising at least one of a DVD players, USB players, wireless transmitters, wireless receivers, fans, and music and video inputs, wherein the equipment is operatively connected to the at least one speaker system.

10. The mobile entertainment device of claim 1, comprising a plurality of accessories, wherein the accessories comprise at least one of lights, an umbrella, USB hub, RCA hub, Multi mixer output, an inverter, a power button for the inverter, a power gauge, a multi light switch, a quad fan, a VGA Splitter, a microphone system, a rack mount drawer, a removable rack mount, a power conditioner, a voltage meter, an HDMI converter, fuses for the battery, fuses for the inverter, a plurality of beach wheels, a weather protective covering, a hula hoop, plastic to cover the monitors, a video sensor, a backup audio sensor, battery disconnects, and a surge protection inverter.
